(19) United States
(12) Patent Application Publication
(10) Pub. No.: US 2014/0165888 A1
(43) Pub. Date: Jun. 19, 2014

(54) SIMULTANEOUS TREATMENT OF FLUE GAS WITH SOx ABSORBENT REAGENT AND NOx REDUCING AGENT

(71) Applicants: Dennis W. Johnson, Simpsonville, SC (US); James H. Brown, Simpsonville, SC (US)

(72) Inventors: Dennis W. Johnson, Simpsonville, SC (US); James H. Brown, Simpsonville, SC (US)

(73) Assignee: FLUOR TECHNOLOGIES CORPORATION, Aliso Viejo, CA (US)

(21) Appl. No.: 14/116,286

(22) PCT Filed: May 9, 2012
(86) PCT No.: PCT/US2012/037146

§ 371 Date: Mar. 5, 2014

Related U.S. Application Data
(60) Provisional application No. 61/484,515, filed on May 10, 2011.

(51) Int. Cl. B01D 53/60; F23J 15/04; B01D 53/50

(52) U.S. Cl. CPC B01D 53/60; B01D 53/50; F23J 15/04
USPC 110/215; 423/242.1; 423/235

(57) ABSTRACT

A system and method for treating flue gas that results from a combustion process is described. The method and system includes injecting an SOx absorbent reagent into the flue gas pathway at a point upstream of a selective catalytic reduction (SCR) reactor exit and downstream of a boiler exit. The method and system may also include injecting a NOx reducing agent simultaneously with the SOx absorbent reagent, either via the same injection system or via a second injection system located nearby the SOx absorbent reagent injection system. Injection of the SOx at a point upstream of the SCR reactor exit simplifies the injection systems, gas distribution systems, and physical and/or computational fluid dynamics modeling.

This application claims the benefit of priority to application Ser. No. 61/484,515, filed on May 10, 2011. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is post-combustion flue gas treatment, more specifically, combined injection systems.

### BACKGROUND

Fossil fuel combustion is an important source of power generation, and is responsible for supplying a major portion of the world's power needs. Unfortunately, the exhaust gases that result from burning fossil fuels, called “flue gases,” contain many harmful air pollutants, such as nitrogen oxides (NOₓ), sulfur oxides (SOₓ), carbon monoxide, carbon dioxide, hydrogen, mercury, ash, and other volatile organic compounds and heavy metals. These flue gases are a major contributor of pollutants to the atmosphere and environment.

Many national and local governments have enacted environmental laws and regulations in order to limit and/or restrict the release of specific pollutants into the environment. In response, power production entities have developed and implemented new systems and methods for removing pollutants from flue gases. These new systems and methods add significant complexity and costs to power production, resulting in higher prices to the consumer. There is great need for improved flue gas treatment methods and systems, in order to decrease the costs and complexity of power production.

Current post-combustion treatment processes utilize a multistage design, in which various oxidizers, sorbents, and/or reducing agents are separately injected into the flue gas at different stages. Each oxidizer, reducing agent and/or absorbent must then be thoroughly mixed with the flue gas before a capture process is performed. This multi-stage approach can be very complex and costly since each targeted pollutant requires its own injection system, gas distribution systems, and physical and/or computational fluid dynamics modeling. It would be advantageous to simultaneously inject different sorbents and reducing agents into the flue gas via one injection system, thereby eliminating the need for multiple injection. It would also be advantageous to inject numerous sorbents and reducing agents in the same general location, thus eliminating the need for multiple distribution systems, flow control devices, and fluid dynamics modeling.

US 2008/0069749 to Liu teaches injecting a compound containing a nitrogen oxide reducing agent (ammonia) and a mercury oxidizer (chloride) upstream from a SCR reactor. Liu appreciates that two pollutants (NOₓ and Mercury) can be simultaneously treated using one injection system. However, Liu fails to appreciate that a sulfur oxide sorbent, such as an alkali compound (magnesium oxide, lime, limestone, sodium carbonate) can be simultaneously injected with a nitrogen oxide reducing agent, such as ammonia, upstream of a SCR reactor in order to treat a flue gas for both NOx and sulfur oxides at the same time.

Canadian Patent Application No. 2628198 to Radway appreciates that alkaline earth carbonates can be injected into the high temperature zone of a furnace to capture SOₓ. However, Radway fails to provide systems and methods for simultaneously injecting an SOx sorbent and an NOx reducing agent to simultaneously treat a flue gas for both NOx and sulfur oxides. For example, introducing a NOx reducing agent (e.g., ammonia) into the high temperature zone of the furnace described in Radway would not treat the flue gas since the amount of heat present would prevent the NO_{R} reducing agent from bonding with NOₓ.

Thus, there is still a need for improved flue gas treatment methods and systems that simultaneously treat a flue gas for NOₓ and sulfur oxides and minimize injection systems and gas distribution components.

### SUMMARY OF THE INVENTION

The inventive subject matter provides apparatus, systems and methods in which flue gas from a combustion process is treated by injecting an SOₓ absorbent reagent into a flue gas pathway at an injection point just upstream of, or within close vicinity to, a selective catalytic reduction (SCR) reactor and downstream from a boiler. The SOₓ absorbent reagent is injected into the pathway via an injection system. The injection system is preferably configured to simultaneously inject both an NOₓ reducing agent and an SOₓ absorbent reagent. In this manner, the need for separate injection systems, gas distribution/mixing systems, and computational/physical fluid dynamics modeling is eliminated. The advantages of the system and methods described herein include reduced capital and operating costs, simplified process and systems, and improved sorbent utilization (e.g., ammonium bisulfate formation is minimized).

The SOₓ absorbent reagent is preferably an alkali reagent. Specifically contemplated compounds include, but are not limited to, lime, limestone, trona, calcium hydroxide, and sodium bisulfate, however any compound suitable for SOₓ capture can be used consistently with the inventive concepts taught herein. The NOₓ reducing agent is preferably ammonia or urea, although all compounds suitable for NOₓ reduction are contemplated.

The injection system preferably injects the absorbent and reducing agent at a point just upstream of, or within close vicinity to, the SCR reactor inlet, to take full advantage of the mixing characteristics at the SCR reactor inlet and inside the SCR reactor. The injection point is preferably located downstream of the boiler and an economizer, in a temperature region of approximately 550-850° F.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

The injection system is especially configured to inject a mixture of SOₓ absorbent and NOₓ reducing agent in a manner such that SOₓ and NOₓ can be captured and removed from the flue gas. In one embodiment the injection system is configured to inject an atomized slurry, thus introducing fine particles of the absorbent and reducing agent.

Other aspects of the invention include a flue gas treatment system comprising: (i) a boiler, (ii) an SCR reactor having an inlet fluidly connected to the boiler exit, and (iii) an injection system fluidly coupled to the SCR reactor. The injection system is preferably configured to inject an SOₓ absorbent reagent at an injection point downstream of the boiler outlet and upstream of the the SCR reactor exit. The injection system can also be configured to simultaneously inject a mixture of SOₓ absorbent reagent and NOₓ reducing agent, (e.g., calcium hydroxide and ammonia) as an atomized slurry.

Other preferred embodiments include a system comprising: (i) a boiler, (ii) an SCR reactor having an inlet fluidly connected to the boiler exit, (iii) a first injection system for injecting an SOₓ absorbent reagent, and (iv) a second injection system for injection an NOₓ reducing agent. Each injection system is preferably located at a point just upstream of the SCR reactor inlet and within close proximity of one another. In this manner, each injection system takes full advantage of the known mixing characteristics of the SCR reactor. It is also contemplated that the injection points for the first and second injection systems can be located just after the SCR reactor inlet and just upstream of the flow distribution and mixing devices. Preferably, the SOₓ absorbent injection system is configured to inject small particles of an absorbent, either as dry powder or as an atomized slurry.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of a prior art system for treating a flue gas.

FIG. 2 shows a schematic of one embodiment of a flue gas treatment system.

FIG. 3 shows a schematic of another embodiment of a flue gas treatment system.

### DETAILED DESCRIPTION

One should appreciate that the disclosed techniques provide many advantageous technical effects including reducing system components and simplifying processes for flue gas treatment.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

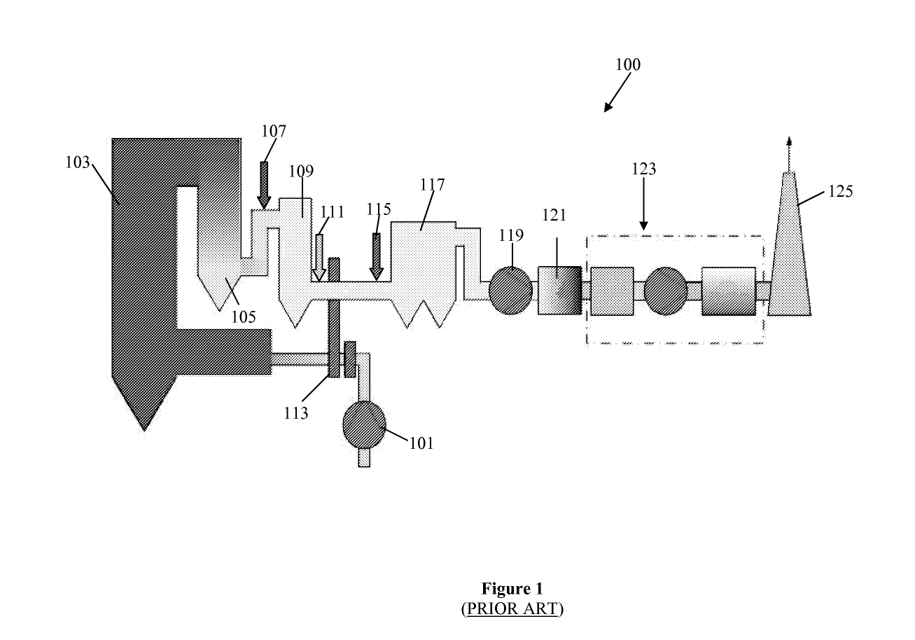

FIG. 1 shows a prior art flue gas treatment system 100 for removing NOₓ, SOₓ, mercury, and CO₂ from flue gas. Boiler 103 is configured to burn a fuel (e.g., coal, gas). Forced draft fan 101 blows the flue gases resulting from the combustion process through boiler 103 and to economizer 105. Economizer 105 is configured to provide heat exchange between the flue gas and a colder fluid. Following the economizer 105 is a NOₓ reducing agent injection system 107 fluidly coupled with a connecting conduit and a flue gas pathway that flows from economizer 105 to a selective catalytic reduction (SCR) reactor. As used herein, “fluidly coupled” simply means that an injection system is capable of introducing a composition a flue gas. Injection system 107 is configured to inject a NOₓ reducing agent (e.g., ammonia) into the flue gas pathway. SCR reactor 109 is configured to mix the flue gas and NOₓ reducing agent. Reactor 109 is also configured to covert NO into diatomic nitrogen (N₂) and water (H₂O) by reaction of the reducing agent on a catalyst surface. Following reactor 109 is an SOₓ absorbent reagent injection system 111, which is configured to inject an SOx absorbent reagent (e.g., limestone) into the flue gas pathway. Air pre-heater 113 then heats the flue gas and limestone mixture. An activated carbon injection system 115 then injects activated carbon into the flue gas pathway. Electrostatic precipitator (ESP) 117 is then provided in order to collect particulate (e.g., ash) from the flue gas via an induced electrostatic charge and fabric filters. An induced draft fan 119 pulls the cleaned flue gas out of ESP 117 and into flue gas desulfurizer (FGD) 121, where SO₂ is removed from the flue gas. The flue gas then passes through a CO₂ treatment process 123 (e.g., Econamine FG Plus^{SM}) and out of system 100 via chimney 125.

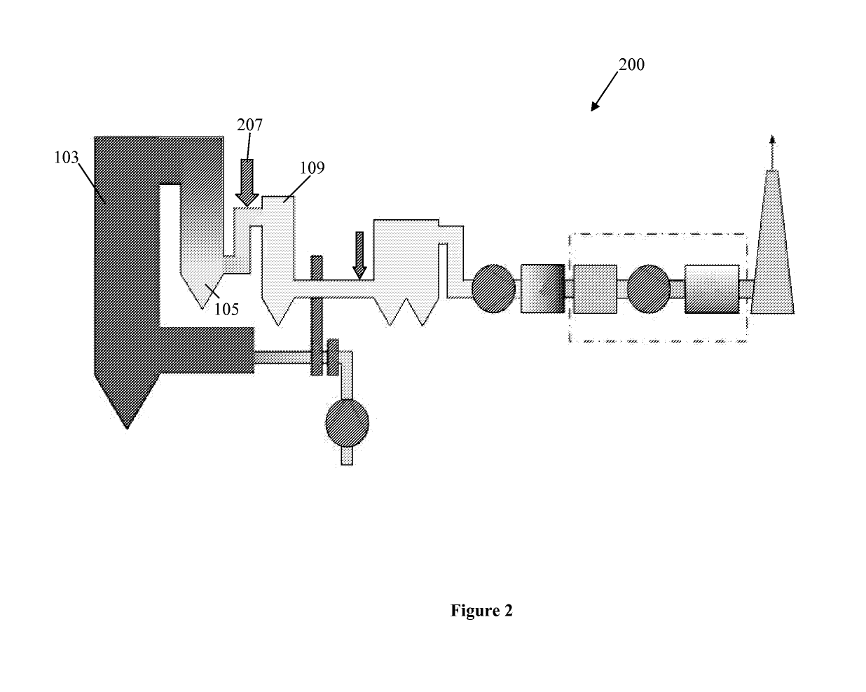

FIG. 2 shows a flue gas treatment system 200, which is similar to system 100 of FIG. 1 except that injection system 111 has been removed and injection system 107 has been converted into injection system 207. Injection system 207 is configured to simultaneously inject a mixture of NOₓ reducing agent and SOₓ absorbent reagent as an atomized slurry. As used herein, “simultaneously” means within close physical proximity and close in time.

System 200 has at least the following advantages over system 100: (1) the costs of capital, operation, and maintenance have been significantly reduced, since injection system 111 and related distribution devices (not shown) have been eliminated; (2) injection system 207 takes advantage of the flow and mixing characteristics of the SCR reactor 109 in order to mix both the NOₓ reducing agent and SOₓ absorbent reagent; (3) utilization of the SOx absorbent reagent is improved; (4) ammonium bisulfate formation (that results from the presence of NOx reducing agents and SOx in the SCR reactor) is reduced; and (5) the overall flue gas treatment process is simplified. As used herein, “flue gas treatment” means a flue gas is modified for the purposes of eventually removing, capturing, or destroying unwanted molecules in the flue gas. Flue gas treatments may include, but are not limited to, (i) introducing new molecules (e.g., NOx reducing agents, SOx absorbent reagents, and activated carbon) into the flue gas, (ii) modifying flue gas temperature and pressure, and (iii) separating and removing flue gas constituents (e.g., ash).

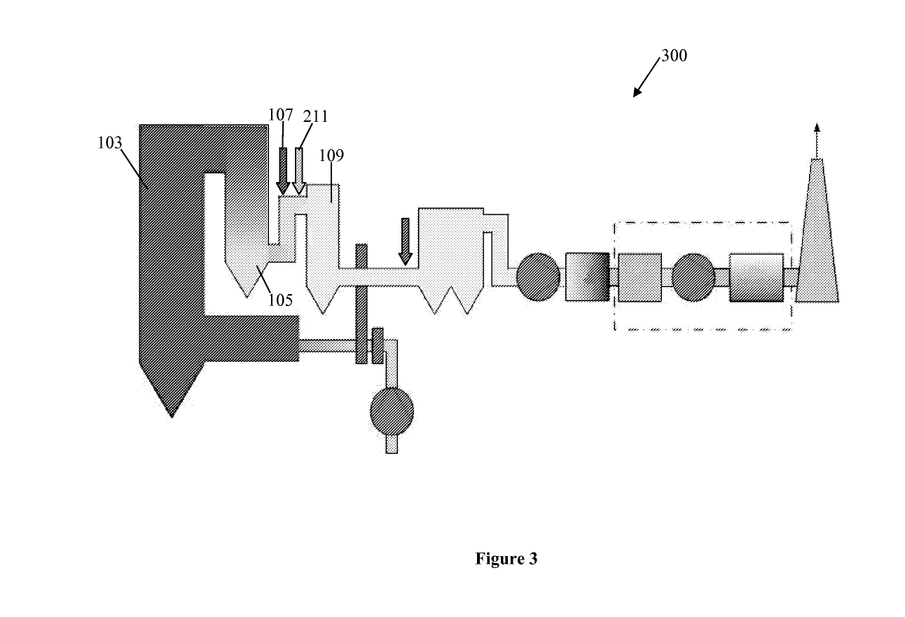

FIG. 3 is similar to FIG. 1, except that injection system 111 has been replaced with injection system 211. Injection system 211 is within close proximity of injection system 107, and is located just upstream of the SCR reactor 109. Injection system 211 is configured to inject SOx absorbent reagent into the flue gas pathway in finely-sized particles, either as a dry powder or as an atomized slurry. System 300 has all the advantages of system 200 except that an injection system is not eliminated.

Injection system 211 differs from injection system 207 (see FIG. 2) in that system 211 is dedicated solely to the injection of SOₓ absorbent reagent. System 207, on the other hand, utilizes at least some injection system components to inject both SOₓ absorbent reagent and NOₓ reducing agent. In other words, system 207 at least partially integrates hardware (nozzles, pipes/lines, pumps/compressors) for injecting SOx absorbent reagent and NOx reducing agent. For example, system 207 could utilize the same pump to drive two different sets of nozzles and lines (one for each of the SOx absorbent reagent and NOx reducing agent). In other embodiments, system 207 is completely integrated, meaning that a mixture of SOx absorbent reagent and NOx reducing agent runs through the same pump and lines.

Injection system 207 and 211 could comprise one nozzle, or a plurality of nozzles. When a plurality of nozzles are used, the “injection point” of the injection system can refer to the injection point of one of the nozzles, a general location of a subset of the nozzles, or a general location of all of the nozzles.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of treating flue gas comprising the step of injecting an SOₓ absorbent reagent into a flue gas pathway at a first injection point located upstream of a selective catalytic reduction (SCR) reactor and downstream of a boiler via a first injection system.

2. The method of claim 1, wherein the first injection point is located in a region having a temperature in the range of approximately 550-850° F.

3. The method of claim 1, wherein the SOₓ absorbent reagent is an alkali reagent.

4. The method of claim 1, wherein the SOₓ absorbent reagent is selected from the group consisting of lime, limestone, trona, and sodium bisulfate.

5. The method of claim 1 further comprising the step of injecting an NOₓ reducing agent simultaneously with the SOₓ absorbent reagent via the first injection system.

6. The method of claim 5, wherein the NOx reducing agent is selected from the group consisting of ammonia and urea.

7. The method of claim 1 further comprising the step of injecting an NOₓ reducing agent into the flue gas pathway at a second injection point in close proximity to the first injection point via a second injection system.

8. A flue gas treatment system comprising:
a boiler having a outlet;
a selective catalytic reduction (SCR) reactor having (i) an inlet that is fluidly coupled to the boiler outlet via a connecting conduit, and (ii) an exit;
a first injection system fluidly coupled to the SCR reactor at a first injection point, wherein the first injection point is located downstream of the boiler outlet; and
wherein the first injection system is configured to simultaneously inject an SOₓ absorbent reagent and an NOₓ reducing agent.

9. The flue gas treatment system of claim 8, wherein the first injection point is located within a region between the boiler outlet and the SCR reactor exit.

10. The flue gas treatment system of claim 9, further comprising a flue gas desulfurizer located downstream of the SCR reactor exit.

11. A flue gas treatment system comprising:
a boiler having a outlet;
a selective catalytic reduction (SCR) reactor having (i) an inlet that is fluidly coupled to the boiler outlet via a connecting conduit, and (ii) an exit;
a first injection system fluidly coupled to the SCR reactor at a first injection point, wherein the first injection point is located downstream of the boiler outlet; and
wherein the first injection system is configured to inject a SOₓ absorbent reagent.

12. The system of claim 11 further comprising a second injection system fluidly coupled to the SCR reactor at a second injection point, wherein the second injection point is located within a region between the boiler outlet and the exit region of the SCR reactor.

13. The system of claim 11, wherein the first injection system is fluidly coupled to the SCR reactor indirectly via the connecting conduit.
